(19) United States
(12) Patent Application Publication
(10) Pub. No.: US 2014/0098965 A1
(43) Pub. Date: Apr. 10, 2014

(54) METHOD FOR MEASURING ELECTROACOUSTIC PARAMETERS OF TRANSDUCER

(71) Applicant: FENG CHIA UNIVERSITY, Taichung (TW)

(72) Inventors: Chi-Chang WANG, Taichung (TW); Jin-Huang HUANG, Taichung (TW); Yu-Ting TSAI, Taichung (TW)

(73) Assignee: FENG CHIA UNIVERSITY, Taichung (TW)

(21) Appl. No.: 13/728,445

(22) Filed: Dec. 27, 2012

(30) Foreign Application Priority Data
Oct. 9, 2012 (TW) 101137199

(51) Int. Cl. H04R 29/00

(52) U.S. Cl. CPC H04R 29/001
USPC 381/59

(57) ABSTRACT

A method discloses measuring electroacoustic parameters of transducer. With known voice-coil displacement, voice-coil current, transducer impedance and its stimulus signal as inputs, the five calculation procedures of direct problem, adjoint problem, sensitivity problem, conjugate gradient method, and constraint equations are involved in inversely solving electroacoustic parameters. The presented method has the characteristics of high efficiently, low iterations for computational algorithm, and high accuracy for electroacoustic parameters estimation. Through the numerical result and discussion, the relative errors between estimated and accurate electroacoustic parameters are sufficiently small even with the inclusion of the inevitable measurement errors. These results indicate that the presented method has high feasibility for estimating electroacoustic parameters of a transducer.

### CROSS-REFERENCE TO RELATED APPLICATION

This application claims priority from application No. 101137199, filed on Oct. 9, 2012 in the Taiwan Intellectual Property Office.

### FIELD OF THE INVENTION

The invention relates to a method for measuring electroacoustic parameters of a transducer, and more particularly, to a method using known voice-coil displacement, voice-coil current, transducer resistance and its stimulus signal as inputs to maintain relative errors between estimated and actual electroacoustic parameters sufficiently small even with the inclusion of inevitable measurement errors.

### BACKGROUND OF THE INVENTION

Following the steps of modern technology, loudspeaker (electroacoustic transducer) gradually evolves from the original receiver to whatever it is today and has become an essential element in our daily life. Small as our cell-phones and large as the boom-boxes in big concert, loudspeakers are everywhere. In addition, following the demands to daily life quality, requirements as well as demands to the loudspeakers have never been lessened. In order to meet these requirements from all walks of life, loudspeakers of different kinds are developed to the market.

There are various kinds of loudspeakers in the commercial market. Generally, they can be categorized by their working principles, i.e., moving coil loudspeaker, electromagnetic loudspeaker, electrostatic loudspeaker and piezoelectric loudspeaker. In all the loudspeakers above, the moving coil loudspeaker is the most popular one for its compact size and characterized bandwidth and thus vastly applied in different fields. The structure of this moving coil loudspeaker is mainly composed of a magnetic loop system (magnet under yoke and polar piece), a vibration system (diaphragm and voice coil) and a support and suspension system (spider or damper, edge or surround).

With the mature of nanotechnology and broadly applied to all kinds of 4C electronic appliances, people's lives with mobile devices are becoming more and more convenient, so are the use of voice communication and cloud data linkage. Demand of moving coil loudspeaker is unprecedently high in history as the fast development of mobile micro-electronic devices. When people are used to use all kinds of listening devices for spiritual satisfaction, the pursuit for sound quality is also increased. For example, the design and composition of the moving coil loudspeaker can use the Lumped parameter model, presented by scholars and also called loudspeaker lump parameter model, as references for material and mechanical design. The lump parameter model includes mechanical acoustic resistance principle and has emphasis on the loudspeaker design as well as the operation concept. As a result, in the development of moving coil loudspeaker, lump parameter model are vital method and solutions for questions such as the design and references for material, prediction for frequency response and parameter valuation so as to provide verification and prediction of sound quality and frequency response trend. Therefore, searching for loudspeaker parameters and understanding changes of loudspeaker parameters are keys to grasp the goal and direction of loudspeaker design.

In analysis of moving coil loudspeaker, conventionally, researchers use lumped parameter model as the analyzing tool, which includes an important set of physical quantities parameters and is composed of three different systems, namely, magnetic loop system, vibration system and support and suspension system. The magnetic loop system includes parameters such as voice coil inductance le, and voice coil resistance Re. The vibration system and the support and suspension system include parameters as moving mass (including air load) Mm, mechanical suspension stiffness Km, mechanical suspension resistance Rm and force factor Bl.

Conventionally, there are two ways of measuring loudspeaker parameters:

a). placing loudspeaker in a close box to allow the additional compliance in the close box to measure the parameters, which is called close box method; and

b). placing a small mass on the damper of the loudspeaker to measure the loudspeaker parameters, which is called add mass method.

These two methods both alter the peak values of the resistance-frequency curve and frequencies and the changes thereof lead to electroacoustic parameters. Therefore, another method of using electrical resistance and velocity-voltage transfer function data to measure electroacoustic parameters via signal filtering process is developed.

Further, another method, system identification, for loudspeaker electroacoustic parameters is introduced, which is accomplished by measuring input voltage, coil current and coil displacement and thus the loudspeaker parameters are obtained via the characteristics of the function. Due to low accuracy of the resulted parameters and requirement for high precision processor, this method is not vastly applied to the related product.

Currently, there are German Klippel and LMS, Soundcheck 3 of the United States of America produce laser measuring equipment for measurement of loudspeaker parameters, wherein the diaphragm displacement is used to transform into the loudspeaker parameters. These laser measuring equipments cost from hundred thousand to millions depending on the precision. In addition, the application of this kind of equipment needs assistance of a highly precise microphone (without the need of a soundproof room) to measure the loudspeaker sound pressure and then the sound pressure is transformed into the required parameter. Often in time, the highly precise microphone costs about 20 hundred thousand to one million depending on the sensitivity (in association with a soundproof room).

As a result of the above analysis to the modern technology, the current laser measuring equipment or a high precision sensing device (microphone) are necessary for measurement of coil vibration. Therefore, the price as well as the licensing fee is high.

Furthermore, the use of a thermoacoustic cooler to measure loudspeaker parameters requires the presence of a thermoacoustic cooler. Different sizes of thermoacoustic coolers are required for loudspeakers of different sizes. Also, the measurement steps are complicated.

### SUMMARY OF THE INVENTION

The primary objective of the preferred embodiment of the present invention is to provide a method for measurement of loudspeaker parameters via measuring loudspeaker coil displacement and current. With the construction of electroacoustic reverse computation theory, the unknown parameters such as mechanical parameters as well as force factor, i.e., mass, resistance coefficient, stiffness coefficient of the damper suspension system are predicted.

In order to achieve the above objective, the parameter measuring method of the preferred embodiment of the present invention at least includes:

defining an object function based on a measured displacement of a loudspeaker coil and an estimated function for the loudspeaker coil displacement, wherein the estimated function includes multiple electroacoustic parameters;

optimizing the estimated function to obtain an optimized function to replace the estimated function, wherein the optimizing step includes:
assuming electroacoustic parameters of the estimated function;
calculating the estimated function with a numeric method;
calculating a gradient of the objective function to obtain a search direction;
calculating the search direction to obtain a forward step; and
calculating the search direction and the forward step to obtain the optimized function;

calculating the optimized function based on a loudspeaker resistance to check matching with the measured result; and

repeating above steps to match the optimized function with the measured result so as to obtain the electroacoustic parameters.

In a preferred embodiment, the electroacoustic parameter includes at least mass coefficient Mₘ, resistance coefficient Rₘ, stiffness coefficient Kₘ and force factor Bl.

In a preferred embodiment of the present invention, the numeric method is finite difference method or finite element method.

In a preferred embodiment of the present invention, the optimized method is conjugated gradient method, CGM, or steepest decent method, SDM.

In a preferred embodiment of the present invention, a step of defining a controlling function for the loudspeaker is added before the object defining step.

In a preferred embodiment of the present invention, a step of calculating the gradient based on the object function and the controlling function is added to the gradient calculating step.

Because the object function is defined based on the measured loudspeaker coil displacement and the estimated function for the loudspeaker coil displacement and the estimated function is calculated via the optimized method to obtain the optimized function to replace the estimated function, the electroacoustic parameters are obtained with the estimated function approaching to the measured value.

Thus, the sales price and licensing fee for the conventional loudspeaker parameter equipment being high are solved. It is worth notice that the embodiments of the present invention present a concept of obtaining or predicting unknown parameters such as mass, resistance coefficient, stiffness coefficient of the suspension system and force factor via electroacoustic reverse calculation theory, which is fast and capable of avoiding complex operational procedure, expensive devices and restraints of the loudspeaker sizes. Also, linear or non-linear electroacoustic parameters are obtained.

### BRIEF DESCRIPTION OF THE DRAWINGS

FIG. 1 is a schematic view showing the embodiment of the present invention explaining the circuit diagram of lumped parameter model of the moving coil loudspeaker;

FIG. 2 is a flow chart showing the measuring method of the loudspeaker parameters of the present invention;

FIGS. 3a and 3b are still schematic views showing the comparison of the predicted displacement Xᵢₙᵥ and current Iᵢₙᵥ obtained via reverse calculation with the correct value;

FIG. 4 is a schematic view of still another embodiment of the present invention showing a comparison between the mass coefficient Mₘ reverse calculation;

FIG. 5 is a schematic view showing another embodiment of the present invention depicting the resistance coefficient Rₘ reverse calculation;

FIG. 6 is another embodiment of the present invention explaining the stiffness coefficient Kₘ reverse calculation; and

FIG. 7 is another embodiment of the present invention explaining the force factor Bl reverse calculation.

### DETAILED DESCRIPTION OF THE INVENTION

Inverse Problem in Differential Equation is a science between mathematics and engineering and because it has vast applications in different fields, scientists begin to focus their attentions on this subject. Inverse problem in differential equation is contrast to direct problem in differential equation. The direct problem in differential equation is a science to research how to describe the physical processes, states, changes and reactions so as to establish differential equation. Based on specific conditions (initial or boundary conditions) in the processes and states, the solution(s) is to be solved and thus a mathematical description to the processes and states is obtained. On the contrary, if there is an unknown parameter in the differential equation, the equation is called inverse problems in differential equation.

Nowadays, as the size of 3C device continues to shrink, the difficulty of measuring the electroacoustic parameters continues to escalate. To solve this problem, the inverse process in differential equation is able to obtain satisfied answers via numerical calculation of computers to problems or questions such as parameters unable to be precisely measured, expensive measuring equipment and complicated operation procedures.

Typical moving coil of the loudspeaker contains energy transfer among electrical, mechanical and acoustic fields. Because the wavelength of the moving coil loudspeaker in low frequency is larger than the geometric pattern of the loudspeaker, it is possible to lump the parameters in electrical, mechanical and acoustic fields.

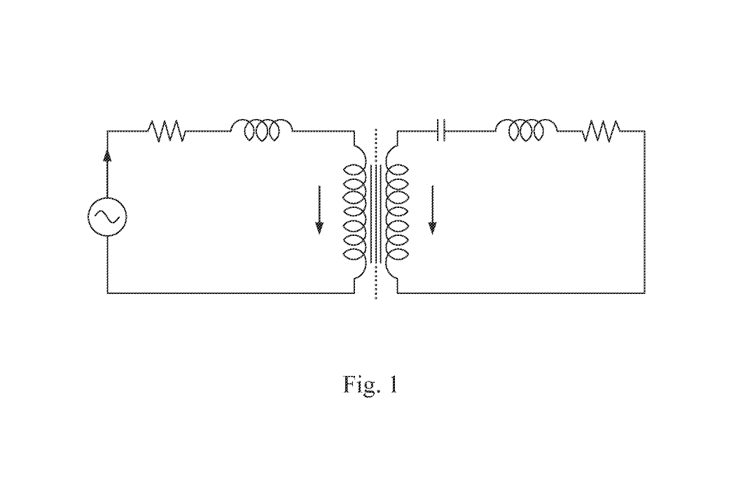

With reference to FIG. 1, a circuit diagram of the lumped parameters of the moving coil loudspeaker is shown and contains a magnetic system transforming an electrical signal into magnetization induced moving coil and a damper suspension system induced by operation of the coil. The described parameters in electrical field includes input voltage e(t), resistance of the direct current of the coil Rₑ and inductor Lₑ. The electroacoustic parameters in mechanical field contain stiffness coefficient Kₘ of the damper suspension system of the loudspeaker, mass coefficient Mₘ and resistance Rₘ. In addition, the electro-engineering transforming coefficient connecting the electrical field and the mechanical field is force factor Bl. The six different electroacoustic parameters form a system parameter of the loudspeaker lump parameter. By way of the lump parameter model in FIG. 1, a controlling equation for the loudspeaker is:

$$\begin{matrix}{M}_{m} \frac{{d}^{2} x}{d {t}^{2}} + {R}_{m} \frac{d x}{d t} + {K}_{m} x = B li & ( 1 ) \\ {L}_{e} \frac{d i}{d t} + {R}_{e} i + B l \frac{d x}{d t} = e ( t ) & ( 2 )\end{matrix}$$

Assuming the initial conditions, such as, displacement x(t), speed and current i(t) of the loudspeaker are known, under the known electroacoustic parameters (Mm, Rm, Km, Bl, Re, Le), the coil vibration is solved. This is Well-posed problem and the solution thereof is direct solution. On the contrast, when t∈(0,t_{f}), and the input voltage e(t), coil displacement x(t) and current i(t) are known, the unknown parameters are to be inversely calculated, which may be an ill-posed problem and called inverse solution, also, an issue to be discussed in the preferred embodiment of the present invention.

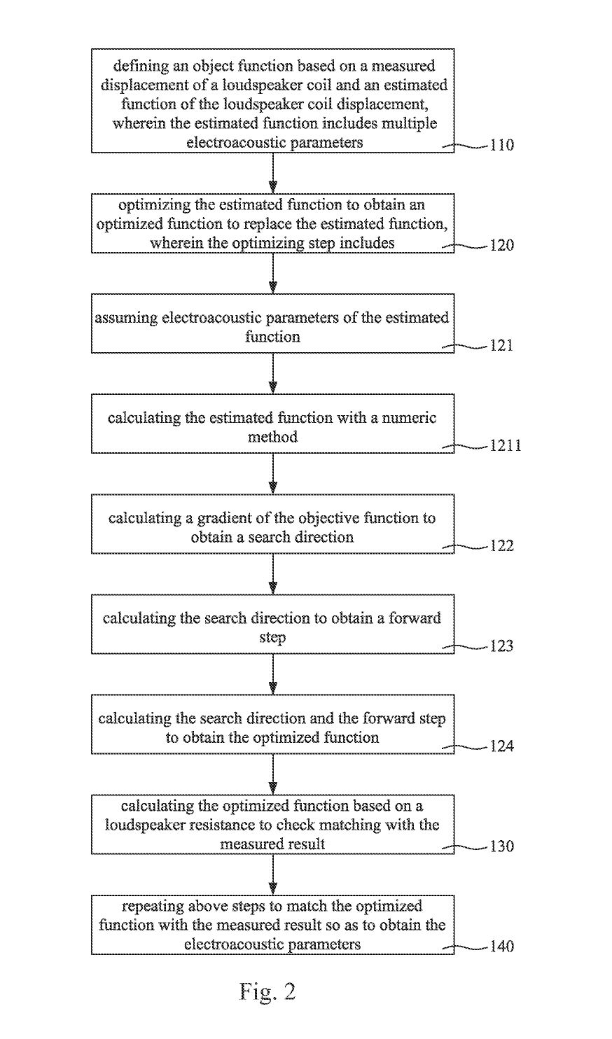

With reference to FIG. 2, a flowchart of the preferred embodiment of the present invention is shown. It is shown that the electroacoustic parameter measuring method for a transducer includes the steps of:

110: defining an object function based on a measured displacement of a loudspeaker coil and an estimated function of the loudspeaker coil displacement, wherein the estimated function includes multiple electroacoustic parameters;

120: optimizing the estimated function to obtain an optimized function to replace the estimated function, wherein the optimizing step includes:

121: assuming electroacoustic parameters of the estimated function;

1211: calculating the estimated function with a numeric method;

122: calculating a gradient of the objective function to obtain a search direction;

123: calculating the search direction to obtain a forward step; and

124: calculating the search direction and the forward step to obtain the optimized function;

130: calculating the optimized function based on a loudspeaker resistance to check matching with the measured result; and

140: repeating above steps to match the optimized function with the measured result so as to obtain the electroacoustic parameters.

In the step of 110, assuming the input voltage e(t), coil displacement x(t)) and current i(t) are known under t∈(0,t_{f}), inversely predicting the unknown electroacoustic parameters and the electroacoustic parameters includes, at least, mass coefficient Mm, resistance coefficient Rm, stiffness coefficient Km and magnetic factor Bl. As a result, it is necessary to define an object function J via the measured value Xmea(t) and the estimated function of the direct problem, wherein the object function J is:

J(w)=∫₀^{t}^{_{f}}[x(w)−xₘₑₐ]²dt (3)

The vector of the unknown electroacoustic parameter is w=[wₘ, Rₘ, Kₘ, Bl]^{T}. From the above equation, it is noted that when the value of the object function J is extremely small, the value x of the estimated function is close to the measured value xmea, that is, to obtain the best solution of the electroacoustic parameter when the estimated function x gradually approaches to the smallest value.

In step 120, in general, solving the inverse problem includes two parts: analyzing processing and optimizing process. In the analyzing process, the unknown coefficients in differential equation (1) are assumed to be any guessed number. Then via numeric method, such as finite differential method or finite element method, solution to the analyzed result is obtained. The solution is then combined with the measured value to generate a set of nonlinear object square function J as shown in function (3) and the object square function undergoes a minimization process. During the minimization process, by way of the optimized method, such as conjugated gradient method, CGM or steepest decent method, SDM, a new set of value is searched systematically to replace the values of the unknown parameters so as to reduce the object function and obtain a preferred object function. Because SDM has better convergence property along negative gradient direction when being away from extreme value and CGM searching along the conjugated direction based on the negative gradient has secondary convergence property, which is the best Iterative search approach known in the related field. As a result, the CGM is adopted to optimize the preferred embodiment of the present invention. With repeated practice of Iterative approach, the object function is minimized, the involved function is:

w^{(k+1)}=w^{(k)}−β^{(k)}P^{(k+1)} (4)

where k is the power, β^{(k)} is the forward step of k power;

P^{(k)} is the decreasing direction of the known of k power, and

P^{(k+1)}=∇J^{(k)}+γ^{(k)}P^{(k)} (5)

wherein ∇J^{(k)} represents the gradient of the object function after k search(es);

γ^{(k)} is defined as:

$$\begin{matrix}{γ}^{( k )} = \frac{{‖ ∇ {J}^{( k )} ‖}^{2}}{{‖ ∇ {J}^{( k - 1 )} ‖}^{2}} \\ = \frac{{( {M}_{m}^{( k )} )}^{2} + {( {R}_{m}^{( k )} )}^{2} + {( {K}_{m}^{( k )} )}^{2} + {( {Bl}^{( k )} )}^{2}}{{( {M}_{m}^{( k - 1 )} )}^{2} + {( {R}_{m}^{( k - 1 )} )}^{2} + {( {K}_{m}^{( k - 1 )} )}^{2} + {( {Bl}^{( k - 1 )} )}^{2}}\end{matrix} \qquad ( 6 )$$

Note: when γ^{(k)}P^{(k)} is not considered in the decreasing direction, then P^{(k+1)}=∇J^{(k)} in function (5), meantime, CGM retrogrades to SDM.

During the convergence process of CGM, x(t), ∇J and β have to be solved. In the process of solving the functions, direct problem, adjoint function problem and sensitivity problem are respectively formed and will be described in the following.

In step 121, it is a direct problem solving x(t). If the loudspeaker coil displacement is to be solved, a predicted set of

w=[Mₘ, Rₘ, Kₘ, Bl]^{T} is given and the numerical method is employed to solve the equation. In the preferred embodiment of the present invention, the numerical method is finite difference or finite element method. The present invention adopts discretization method to disperse function (1):

$$\begin{matrix}x ( {t}^{n} ) = \frac{{p}^{n - 1} + 10 {p}^{n} + {p}^{n + 1}}{12} & ( 7.1 ) \\ \frac{d x ( {t}^{n} )}{d t} = \frac{{p}^{n + 1} - {p}^{n - 1}}{2 Δ t} - Δ {\dot{x}}^{n} & ( 7.2 ) \\ \frac{{d}^{2} x ( {t}^{n} )}{d {t}^{2}} = \frac{{p}^{n - 1} - 2 {p}^{n} + {p}^{n + 1}}{Δ {t}^{2}} & ( 7.3 )\end{matrix}$$

where p and n are calculation indexes for representative sampling value and time axis and

$$Δ {\dot{x}}^{n} = \frac{Δ t}{24} ( \frac{{d}^{2} {x}^{n + 1}}{d {t}^{2}} - \frac{{d}^{2} {x}^{n - 1}}{d {t}^{2}} ) \qquad ( 7.4 )$$

using the equation above to disperse function (1), then:

$${M}_{m} \frac{{p}^{n - 1} - 2 {p}^{n} + {p}^{n + 1}}{Δ {t}^{2}} + {R}_{m} ( \frac{{p}^{n + 1} - {p}^{n - 1}}{2 Δ t} - Δ {\dot{x}}^{n} ) + {K}_{m} \frac{{p}^{n - 1} + 10 {p}^{n} + {p}^{n + 1}}{12} = Bli \qquad ( 8 )$$

simplifying the above function, then:

$${p}^{n + 1} = \frac{\begin{matrix}12 Bli + 12 {M}_{m} ( 2 {p}^{n} - {p}^{n - 1} ) + \\ Δ t ( {p}^{n - 1} ( 6 {R}_{m} - {K}_{m} Δ t ) + 2 Δ t ( - 5 {K}_{m} + 6 {R}_{m} Δ {\dot{x}}^{n} ) )\end{matrix}}{12 {M}_{m} + Δ t ( 6 {R}_{m} + {K}_{m} Δ t )} \qquad ( 9 )$$

pⁿ⁺¹ is quickly obtained.

With the help of function (7), function x(tⁿ) and any derived function within second order on the mesh are obtained.

It is worth mentioning that in addition to the fact that the values of the above functions are formed by neighboring representative sampling parameters, discretization of the first order and second order differential function x(t) is similar to the conventional finite differential method. As such, the discretization, the calculation process and solution obtaining of the differential equation is quite similar to the conventional finite differential method and completely avoids the bother from the complex calculation of the traditional representative sampling method.

Step 122 is an adjoint equation for its gradient. In the preferred embodiment of the present invention, the gradient is obtained in accordance with the object function and the controlling equation. That is, the object function J and function (1) time a Lagrange multiplier and then combine to have a Lagrange function:

$$\begin{matrix}L ( w , λ ) = J ( w ) + λ h ( w ) \\ = {\int }_{0}^{{t}_{f}} {[ x ( w ) - {x}_{m} ]}^{2} d t + \\ {\int }_{0}^{{t}_{f}} λ ( {M}_{m} \frac{{d}^{2} x}{d {t}^{2}} + {R}_{m} \frac{d x}{d t} + {K}_{m} x - Bli ) d t\end{matrix} \qquad ( 10 )$$

where h(w) is the equality of function (1), h is the restriction equation of Lagrange function. If the unknown vector w has a minor fluctuation δw=[δMₘ, δRₘ, δKₘ, δBl]^{T}, the object function J(w) and x(t) change accordingly to J(w)+δJ(w) and x(t)+δx(t). Inserting the changes into the above function, the organized function is:

$$\begin{matrix}δ L ( w , λ ) = δ J ( w ) + λ δ h ( w ) \\ = {\int }_{0}^{{t}_{f}} 2 ( x - {x}_{m} ) δ x d t + \\ {\int }_{0}^{{t}_{f}} λ ( \begin{matrix}{M}_{m} \frac{{d}^{2} δ x}{d {t}^{2}} + δ {M}_{m} \frac{{d}^{2} x}{d {t}^{2}} + \\ {R}_{m} \frac{d δ {x}_{s}}{d t} + δ {R}_{m} \frac{d x}{d t} + {K}_{m} δx + x δ {K}_{m} - i δ Bl\end{matrix} ) d t\end{matrix} \qquad ( 11 )$$

Expanding the above function:

$$δ L ( w , λ ) = ( {M}_{m} λ \frac{d δ x}{d t} - {M}_{m} \frac{d λ}{d t} δ x ) {\vert}_{0}^{{t}_{f}} + ( {R}_{m} λ δ x ) {\vert}_{0}^{{t}_{f}} + {\int }_{0}^{{t}_{f}} ( {M}_{m} \frac{{d}^{2} λ}{d {t}^{2}} - {R}_{m} \frac{d λ}{d t} + {K}_{m} λ + 2 ( x - {x}_{m} ) ) δ x d t + {\int }_{0}^{{t}_{f}} λ ( \frac{{d}^{2} x}{d {t}^{2}} δ {M}_{m} + \frac{d x}{d t} δ {R}_{m} + x δ {K}_{m} - i δ Bl ) d t \qquad ( 12 )$$

Because x(0) and

$$\frac{d x ( 0 )}{d t}$$

are known, δx(0) and

$$\frac{d δ x ( 0 )}{d t}$$

are all zero. The minor fluctuation δx is not zero and the optimized solution is obtained when δL(w, λ) in the above function is zero, the adjoint function is:

$${M}_{m} \frac{{d}^{2} λ}{d {t}^{2}} - {R}_{m} \frac{d λ}{d t} + {K}_{m} λ = - 2 ( x - {x}_{m} ) , \\ t ∈ ( {t}_{f} , 0 ) \qquad ( 13.1 )$$

The adjoining initial conditions are:

λ(t_{f})=0 (13.2)

dλ(t_{f})/dt=0 (13.3)

Therefore, obtaining the solution of the above equations would have the value of λ(t). Equations (13.1), (13.2) and (13.3) are called adjoint problems. The functions for the adjoint problems are substantially the same as the form of the direct problems. The biggest difference between them is that the solution of the direct problem is the initial condition and the solution of the adjoint problem is the final condition. As such, it is assumed that the minor fluctuation function δJ(w) of the object function J(w) is:

δJ(w)=∫₀^{t}^{_{f}}∇J·δw dt (14)

Comparing the integral elements of the above function with function (14), the gradient of the object function is:

$$∇ J = [ \begin{matrix}\frac{\partial J}{\partial {M}_{m}} \\ \frac{\partial J}{\partial {R}_{m}} \\ \frac{\partial J}{\partial {K}_{m}} \\ \frac{\partial J}{\partial B l}\end{matrix} ] = [ \begin{matrix}{\int }_{0}^{{t}_{f}} λ \frac{{d}^{2} x}{d {t}^{2}} d t \\ {\int }_{0}^{{t}_{f}} λ \frac{d x}{d t} d t \\ {\int }_{0}^{{t}_{f}} λ x d t \\ - {\int }_{0}^{{t}_{f}} λ i d t\end{matrix} ] \qquad ( 15 )$$

After the gradient ∇J of the object function is obtained, γ and search direction P are obtained via functions (5) and (6).

In step 123, obtaining forward step in the sensitivity problem, after the search direction P is certain, a forward step β is yet to be obtained for the next preferred search result. As such,

J(w; βP)=∫₀^{t}^{_{f}}[x(w−βP)−xₘₑₐ]²dt (16)

is taken into consideration.

Expanding x(w−βP) in Taylor expansion and taking only the linear element, the above function may be rewritten as:

J(w; βP)≈∫₀^{t}^{_{f}}[x(w)−βδx(P)−xₘₑₐ]²dt (17)

where δx is the minor fluctuation of x along the P search direction.

Therefore, with

$$\frac{\partial J ( w ; β P )}{\partial β}$$

is zero, the forward step β is:

$$β = \frac{{\int }_{0}^{{t}_{f}} ( x - {x}_{mea} ) δ x d t}{{\int }_{0}^{{t}_{f}} δ {x}^{2} d t} \qquad ( 18 )$$

The minor increment δx of x is obtained via providing a minor fluctuation to function (1) by Perturbation method. That is adding in a small variable δw to the unknown vector w, the estimated function x(t) shall have a small variable δx(t). Therefore, inserting this condition into function (1), a sensitivity problem function is obtained:

$${M}_{m} \frac{{d}^{2} δ x}{d {t}^{2}} + \frac{{d}^{2} x}{d {t}^{2}} δ {M}_{m} + {R}_{m} \frac{d δ x}{d t} + \frac{d x}{d t} δ {R}_{m} + {K}_{m} δ x + x δ {K}_{m} = i δ B l \qquad ( 19.1 )$$

Its initial conditions are:

$$δ x ( t ) = 0 and \\ \frac{d δ x t}{d t} = 0 for t = 0 \qquad ( 19.2 )$$

The minor increment vector [δMₘ, δRₘ, δKₘ, δBl]^{T} is the search direction P.

In step 124, the best function is obtained via the search direction and the forward step from step 122 and step 123.

In step 130, it is to ensure the correctness of the restriction conditions. Because all the unknown electroacoustic parameters w=[Mₘ, Rₘ, Kₘ, Bl]^{T} are the respective coefficients in function (1), solutions via inverse calculation would be indefinite. As a result of this, in search of correct loudspeaker electroacoustic parameters, the resistance of the loudspeaker under specific frequency resistance is set to be the restriction to find the best solution and see if the best solution is approaching to the correct electroacoustic parameter. The resistance of the loudspeaker is shown as:

$$\begin{matrix}{Z}_{T} = {R}_{e} + {R}_{es} \frac{j Ω / {Ω}_{ms}}{1 - {Ω}^{2} + jΩ / {Q}_{ms}} \\ where & ( 20.1 ) \\ {R}_{es} = \frac{{( B {l}_{exact} )}^{2}}{{R}_{m , exact}} & ( 20.2 ) \\ {Q}_{mS} = \frac{{K}_{m , exact}}{{ω}_{s} {R}_{m , exact}} & ( 20.3 )\end{matrix}$$

ZT is the resistance of the loudspeaker;

Ω is the normalized frequency (relative to resonance frequency ωₛ);

Qms is the mechanical quality factor;

Res is resistance due to mechanical losses, representing the relationship between force factor Bl and force resistance Rm.

Assuming an unknown distance between the unknown electroacoustic parameter w and the correct electroacoustic parameter w_{exact}, then

w_{exact}=ξw^{T}=[ξMₘ, ξRₘ, ξKₘ, ξBl]^{T} (21)

where ξ is a comparison constant between the unknown w and the correct w_{exact}. When ξ approaches to 1, w approaches to w_{exact}. From function (20.2), it is known that the relationship between Res and the unknown electroacoustic parameter (Rm, Bl) is:

$${R}_{es} = ξ \frac{{( B l )}^{2}}{{R}_{m}} \qquad ( 22 )$$

From (20.1) and (20.2), relationship between Res and resistance ZT may again be:

$${R}_{es} = ( {Z}_{T} - {R}_{e} ) \frac{1 - {Ω}^{2} + j Ω / {Ω}_{ms}}{jΩ / {Q}_{ms}} \qquad ( 23 )$$

Separating the real part and the imaginary part of ZT in function (20.1):

$${Z}_{T} = Re [ {R}_{e} + \frac{{R}_{es} {Ω}^{2}}{( {Ω}^{2} + {{Q}_{ms}^{2} ( 1 - {Ω}^{2} )}^{2} )} ] + Im [ \frac{{R}_{es} Ω}{( {Ω}^{2} + {{Q}_{ms}^{2} ( 1 - {Ω}^{2} )}^{2} )} - \frac{{R}_{es} {Ω}^{3}}{( {Ω}^{2} + {{Q}_{ms}^{2} ( 1 - {Ω}^{2} )}^{2} )} ] \qquad ( 24 )$$

Similarly, function (23) is organized via the same method, adopting the real part:

$${R}_{es} = ( Re [ {Z}_{T} ] - {R}_{e} ) \frac{{Ω}^{2} + {{Q}_{ms}^{2} ( 1 - {Ω}^{2} )}^{2}}{{Ω}^{2}} \qquad ( 25 )$$

Inserting (22) into (25), ξ is:

$$ξ = ( Re [ {Z}_{T} ] - {R}_{e} ) \frac{{R}_{m}}{{( B l )}^{2}} \frac{{Ω}^{2} + {{Q}_{ms}^{2} ( 1 - {Ω}^{2} )}^{2}}{{Ω}^{2}} \qquad ( 26 )$$

Inserting (20.3) into (26):

$$\begin{matrix}ξ = ( Re [ {Z}_{T} ] - {R}_{e} ) \frac{{R}_{m}}{{( B l )}^{2}} \frac{{Ω}^{2} + {[ {( \sqrt{{K}_{m} / {M}_{m}} )}^{- 1} {K}_{m} / {R}_{m} ]}^{2} {( 1 - {Ω}^{2} )}^{2}}{{Ω}^{2}} \\ where & ( 27.1 ) \\ {Ω}^{2} = \frac{{ω}^{2}}{{ω}_{s}^{2}} = {( 2 π f )}^{2} \frac{{M}_{m}}{{K}_{m}} & ( 27.2 )\end{matrix}$$

Taking function (27) as the restricting conditions in the conjugated gradient method to proceed iterative procedure to obtain the value of ξ. Following the iterative procedure, ξ gradually approaches to 1, which represents the unknown w converges to the correct w_{exact}.

In step 140, when the best function approaches to the estimated value, the correct electroacoustic parameter is obtained.

The comparison between the optimized method CGM of the present invention with SDM is:

Without the consideration of error occurred during measurement, input an agitated signal e(t) of sine wave with amplitude 1V, frequency f=200 Hz and the loudspeaker electroacoustic parameters (as shown in table 1) are inserted. Then Hybrid spline difference method is employed with t_{f}=2 second timeframe and time period Δt=1/4000, measured values for the loudspeaker coil displacement xₘₑₐ and current iₘₑₐ are simulated. According to inverse calculation in steps 110˜140 in association with the inverse calculation procedure for the solution of CGM moving coil loudspeaker, solution for the electroacoustic parameter of the moving coil loudspeaker is obtained via repeating the inverse calculation. w^{(k)}=[Mₘ^{(k)}, Rₘ^{(k)}, Kₘ^{(k)}, Bl^{(k)}]^{T}

TABLE 1
electroacoustic loudspeaker parameters

| Parameter | Value | Unit |
|---|---|---|
| Re | 3 | Ohm |
| Mm | 1.397E−3 | kg |
| Le | 6.17E−05 | H |
| Rm | 1.061 | Ns/m |
| Km | 1254.7 | N/m |
| Bl | 1.7406 | N/A |

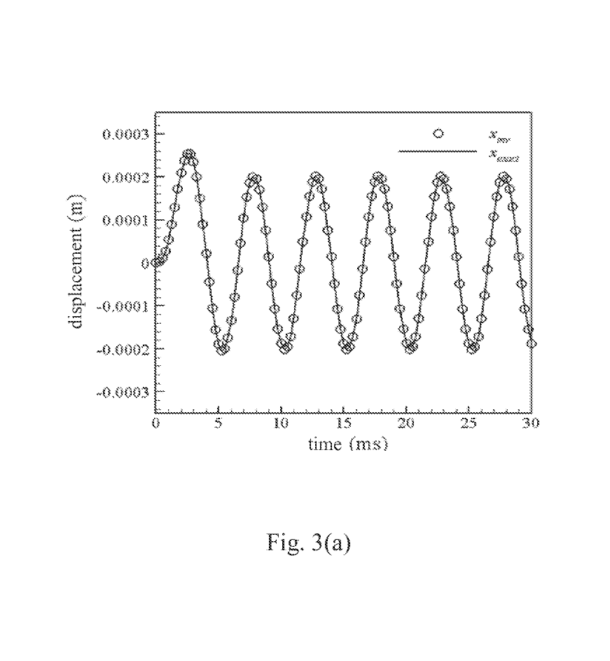

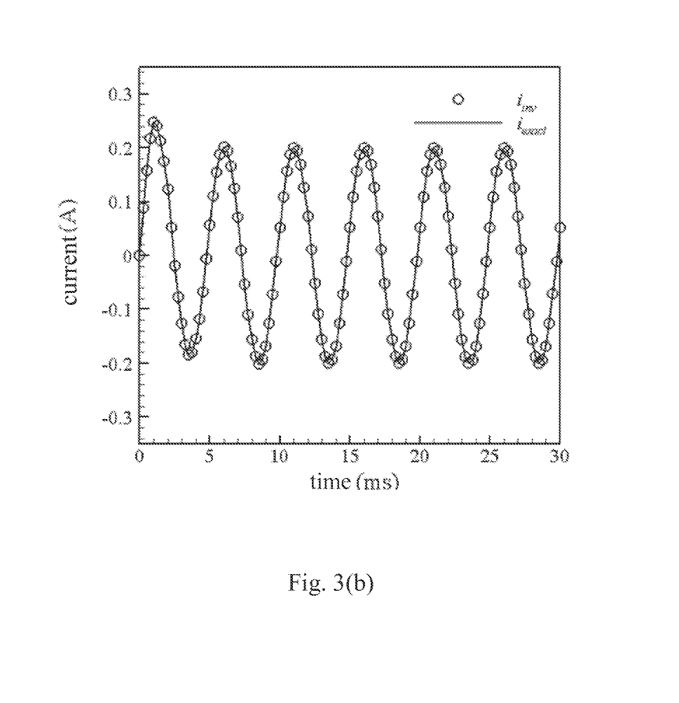

With reference to FIGS. 3a and 3b, the second embodiment of the present invention is shown, respectively showing the comparison of the displacement xinv and current iinv from the result of inverse calculation with the correct values. From the accompanying drawings, it is noted that the prediction from the inverse calculation is close to the correct value, which states that there is not much difference between the measured value and the inversed value. Similarly, as shown in table 2, solutions of the electroacoustic parameters from the result of inverse calculation almost match to the correct electroacoustic parameters.

TABLE 2
Comparison between solutions of the electroacoustic
parameters from the result of inverse calculation
and the correct electroacoustic parameters

| Parameters | Correct values | Inversed values |
|---|---|---|
| Mm | 1.397E−3 | 1.397E−3 |
| Rm | 1.061 | 1.061 |
| Km | 1254.7 | 1254.7 |
| Bl | 1.7406 | 1.7406 |

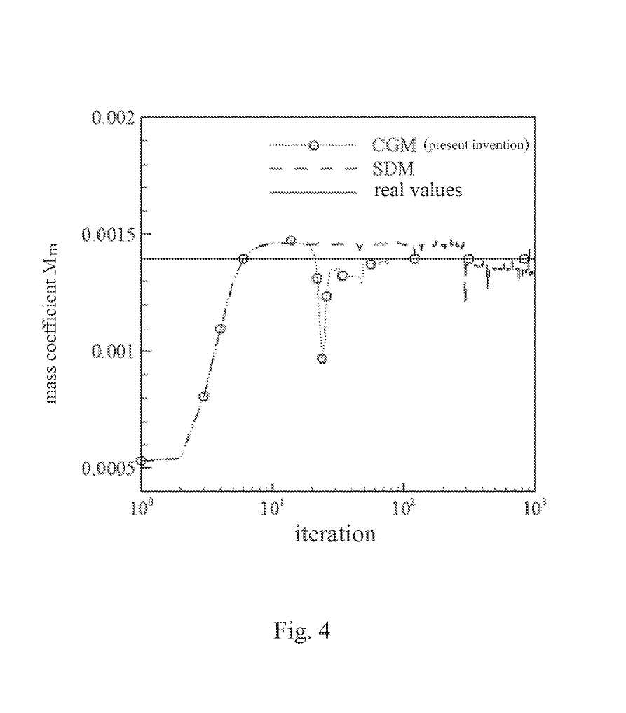

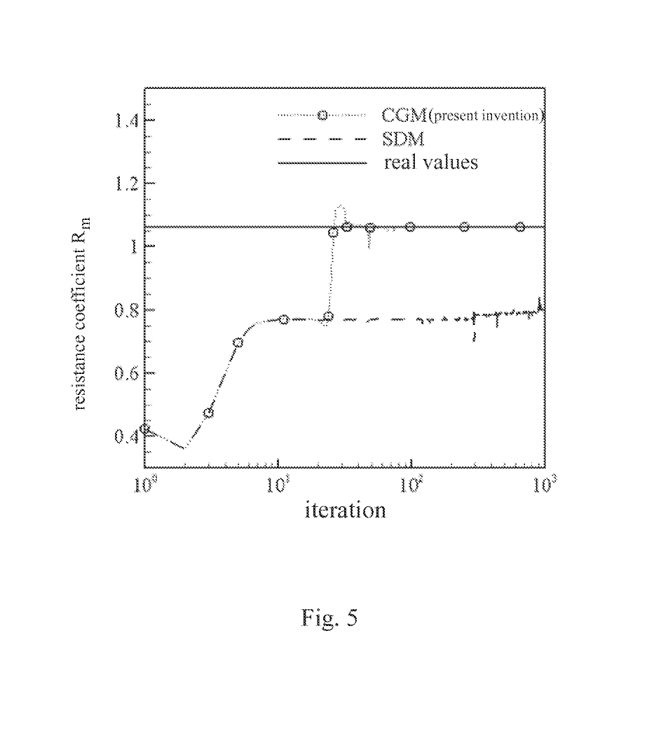

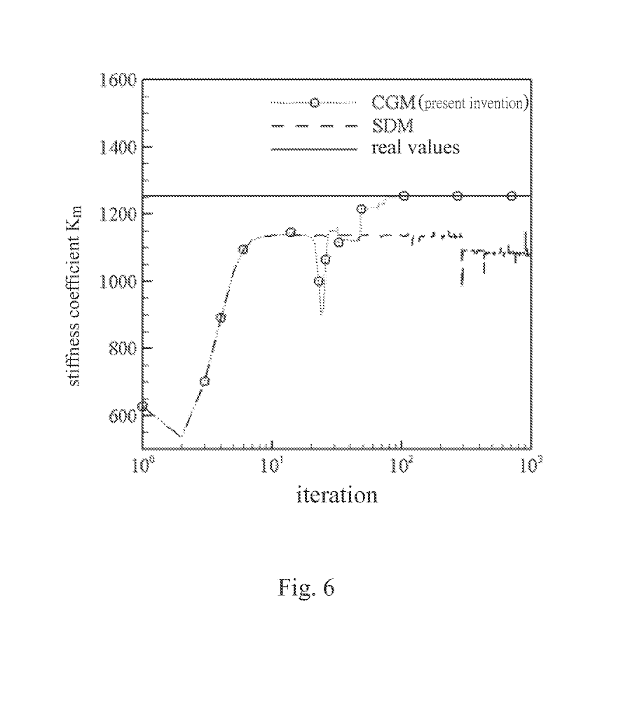

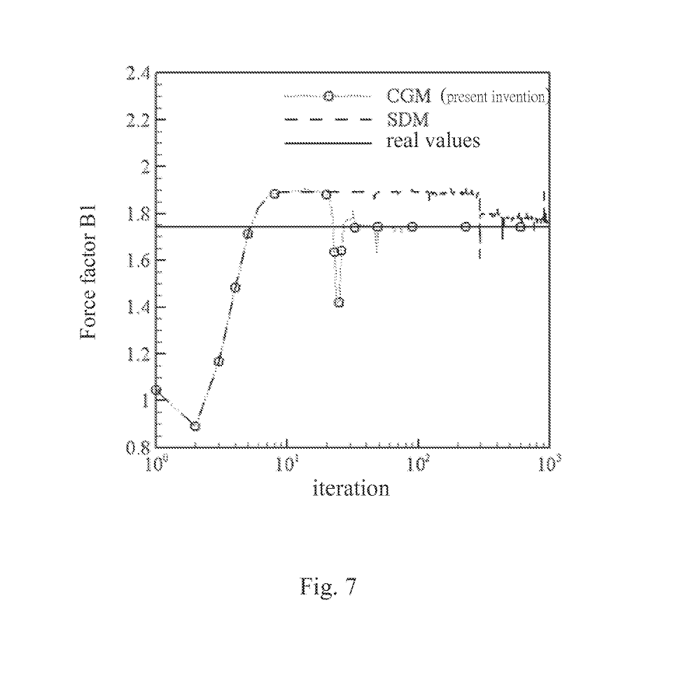

With reference to FIGS. 4 to 7, the third to sixth embodiments of the present invention are shown, respectively showing the convergence comparison after inverse calculation of CGM and SDM to Mₘ, Rₘ, Kₘ, Bl. From the comparison, it is noted that after about 100 iterative, CGM converges to the correct electroacoustic parameters. However, after about 1000 iterative, SDM cannot converge to the correct electroacoustic parameters. From the comparison, it is worth noting that CGM recommended by the context of the present invention is far more effective in inverse calculating parameters than the SDM.

With reference to all the drawings, it is noted that the preferred embodiments of the present invention has the following advantages compared with the conventional technique:

1. applicable to all loudspeakers including linear electroacoustic parameter and nonlinear electroacoustic parameter;

2. all the electroacoustic parameters are solved simultaneously;

3. fast speed, high precision and requires a coulometer, which effectively reduce cost; and

4. academic exploitative and having the capability to further explore formation of nonlinear parameters of other loudspeakers.

What is claimed is:

1. A method for measuring electroacoustic parameters of transducer, the method comprising steps of:
defining an object function based on a measured displacement of a loudspeaker coil and an estimated function of the loudspeaker coil displacement, wherein the estimated function includes multiple electroacoustic parameters;
optimizing the estimated function to obtain an optimized function to replace the estimated function, wherein the optimizing step includes:
assuming electroacoustic parameters of the estimated function;
calculating the estimated function with a numeric method;
calculating a gradient of the object function to obtain a search direction;
calculating the search direction to obtain a forward step; and
calculating the search direction and the forward step to obtain the optimized function;
calculating the optimized function based on a loudspeaker resistance to check matching with the measured result; and
repeating above steps to match the optimized function with the measured result so as to obtain the electroacoustic parameters.

2. The method as claimed in claim 1, wherein the electroacoustic parameters include at least mass coefficient Mₘ, resistance coefficient Rₘ, stiffness coefficient Kₘ and force factor Bl.

3. The method as claimed in claim 1, wherein the numeric method is finite differential method or finite element method.

4. The method as claimed in claim 1, wherein the optimized step is a conjugated gradient method or a steepest decent method.

5. The method as claimed in claim 1, wherein a step of defining a loudspeaker controlling function is added before the object function defining step.

6. The method as claimed in claim 5, wherein the step of calculating the object function gradient further includes obtaining the gradient according to the object function and the controlling function.
